(19) United States
(12) Patent Application Publication
(10) Pub. No.: US 2026/0364534 A1
(43) Pub. Date: Nov. 19, 2026

(54) EXHAUST GAS PURIFICATION CATALYST AND METHOD FOR MANUFACTURING THE SAME

(71) Applicants: TOYOTA JIDOSHA KABUSHIKI KAISHA, Toyota-shi (JP); CATALER CORPORATION, Kakegawa-shi (JP)

(72) Inventors: Masaru KAKINOHANA, Toyota-shi (JP); Himeko KAWAGUCHI, Toyota-shi (JP); Takeshi MORISHIMA, Hamamatsu-shi (JP); Mitsuyoshi OKADA, Hamamatsu-shi (JP); Eiji HARADA, Kobe-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 19/651,145

(22) Filed: Apr. 17, 2026

(30) Foreign Application Priority Data
May 15, 2025 (JP) 2025-082053

(51) Int. Cl. B01D 53/94; B01J 21/04; B01J 21/06; B01J 21/08; B01J 23/42; B01J 23/44; B01J 35/57; B01J 37/02; B01J 37/08

(52) U.S. Cl. CPC B01D 53/945; B01D 53/9413; B01J 35/57; B01J 37/0215; B01J 37/08; B01J 21/04; B01J 21/066; B01J 21/08; B01J 23/42; B01J 23/44

(57) ABSTRACT

In an exhaust gas purification catalyst, a catalyst material is coated inside a porous filter wall of the substrate, and the catalyst material is segregated inside an exhaust gas outflow side of the substrate. In an x-y line diagram with a wall thickness (μm) from an exhaust gas inflow side of the exhaust gas purification catalyst as an x-axis and a porosity (%) at the wall thickness as a y-axis, in a range of a wall thickness from the exhaust gas inflow side of 200 μm or more and 230 μm or less, an integral value of a difference between the porosity at the wall thickness and a porosity of 40% is 587 μm·% or more.

### CROSS REFERENCE TO RELATED APPLICATIONS

The present application claims priority from Japanese patent application JP 2025-082053 filed on May 15, 2025, the entire content of which is hereby incorporated by reference into this application.

### BACKGROUND

### Technical Field

The present disclosure relates to an exhaust gas purification catalyst and a method for manufacturing the same, and more specifically, to an exhaust gas purification filter catalyst and a method for manufacturing the same.

### Background Art

Exhaust gas discharged from an internal combustion engine of an automobile or the like contains particulate matter (PM) mainly composed of carbon which causes air pollution, and this particulate matter can be captured and removed from the exhaust gas by passing the exhaust gas through a filter. Filters having a wall-flow structure are widely used as such filters. Diesel particulate filters (DPFs) for diesel engines, gasoline particulate filters (GPFs) for gasoline engines that emit a certain amount of particulate matter together with exhaust gas, although the amount is less than that of diesel engines, and the like have been developed.

On the other hand, harmful components, such as carbon monoxide (CO), hydrocarbons (HC), and nitrogen oxides (NOX), are contained in exhaust gas, in addition to the particulate matter. The harmful components can be removed from exhaust gas by coating a filter with a catalyst, such as a noble metal catalyst. However, when the filter is coated with a catalyst to improve exhaust gas purification performance, the gas flow channel in a partition wall is blocked or its inner diameter becomes smaller, thereby deteriorating the gas permeability of the partition wall. As a result, pressure loss increases.

To address such a problem, for example, JP 2019-118857 A discloses an exhaust gas purification catalyst, in which a porous filter wall of a substrate having a wall-flow structure is coated with a catalyst material containing an OSC material having oxygen storage capacity and a catalyst metal. In the exhaust gas purification catalyst, when the density of percolation paths having percolation path diameters of 4 μm or more per unit area inside of the filter wall coated with the catalyst material is determined by constructing a three-dimensional model based on three-dimensional shape data obtained by measurement of the filter wall by X-ray CT, extracting a trajectory of a sphere with the maximum diameter that can pass without physically interfering with the filter wall so as to minimize the distance, repeating route search without overlapping of trajectories, and calculating the density of percolation paths having percolation path diameters of 4 μm or more per unit area, the determined density is 100 paths/mm² to 1000 paths/mm².

However, only the number of percolation paths is specified in JP 2019-118857 A, and the macroscopic state of the catalyst material to be coated is not specified. Therefore, low pressure loss cannot be realized by segregating the catalyst material, resulting in a high pressure loss state.

The present disclosure provides an exhaust gas purification catalyst in which an increase in pressure loss is suppressed and a method for manufacturing the same.

### SUMMARY

The inventors examined various means to solve the problem and found that an increase in pressure loss of an exhaust gas purification catalyst can be suppressed by segregating a catalyst material to the outflow side of the exhaust gas and further specifying the degree of segregation by numerical value. Thus, the inventors achieved the present disclosure.

That is, the gist of the present disclosure is as follows.
(1) An exhaust gas purification catalyst comprising:
   a substrate having a wall-flow structure, and a catalyst material being coated inside a porous filter wall of the substrate,
   wherein the catalyst material is segregated inside an exhaust gas outflow side of the substrate, and
   wherein in an x-y line diagram with a wall thickness (μm) from an exhaust gas inflow side of the exhaust gas purification catalyst as an x-axis and a porosity (%) at the wall thickness as a y-axis, in a range of a wall thickness from the exhaust gas inflow side of 200 μm or more and 230 μm or less, an integral value of a difference between the porosity at the wall thickness and a porosity of 40% is 587 μm·% or more.
(2) The exhaust gas purification catalyst according to (1),
   wherein a coating amount of the catalyst material is in a range of 30 g/L or more and 200 g/L or less, with respect to a substrate volume.
(3) A method for manufacturing an exhaust gas purification catalyst including a substrate having a wall-flow structure, and a catalyst material being coated inside a porous filter wall of the substrate, the method comprising:
   coating the filter wall of the substrate with a slurry containing a catalyst material from an exhaust gas outflow side after adding a polyethylene oxide-based viscosity modifier to the slurry to obtain an exhaust gas purification catalyst in which the catalyst material is coated inside the filter wall; and
   drying and firing the exhaust gas purification catalyst in which the catalyst material is coated inside the filter wall.
(4) The method according to (3),
   wherein a slurry viscosity after adding the viscosity modifier is adjusted to less than 2000 m·Pas under conditions of a measurement temperature of 25 °C and a shear rate of 4s⁻¹.
(5) The method according to (3) or (4),
   wherein in the drying the exhaust gas purification catalyst in which the catalyst material is coated inside the filter wall, a temperature of a drying air is in a range of 50 °C or higher and 200 °C or lower, and a wind speed of the drying air is in a range of 1 m/s or more and 10 m/s or less.

With the present disclosure, an exhaust gas purification catalyst in which an increase in pressure loss is suppressed and a method for manufacturing the same can be provided.

### BRIEF DESCRIPTION OF THE DRAWINGS

FIG. 1 is a perspective view schematically illustrating one embodiment of an exhaust gas purification catalyst of the present disclosure;

FIG. 2 is a schematic diagram of an enlarged part of a cross-section cut in the axial direction of one embodiment of the exhaust gas purification catalyst of the present disclosure;

FIG. 3 is an SEM image of a filter catalyst of Example 1;

FIG. 4A is an x-y line diagram of the filter catalyst of Example 1, with a wall thickness (μm) from the exhaust gas inflow side as the x-axis and a porosity (%) at the wall thickness as the y-axis;

FIG. 4B is a diagram indicating an area S of the filter catalyst of Example 1 as the hatched portion;

FIG. 5 is a graph showing the relationship between the area S and product pressure loss; and

FIG. 6 is a cross-sectional schematic diagram of the filter walls of filter catalysts of a comparative example and an example.

### DETAILED DESCRIPTION

The following describes embodiments of the present disclosure in detail.

In the description, features of one aspect of the present disclosure will be described with reference to the drawings, as necessary. In the drawings, dimensions and shapes of respective components are exaggerated for clarification, and actual dimensions and shapes are not accurately illustrated. Accordingly, the technical scope of one aspect of the present disclosure is not limited to the dimensions or the shapes of respective components illustrated in the drawings. Note that one aspect of the present disclosure is not limited to the embodiments below, and can be performed in various configurations where changes, improvements, and the like that a person skilled in the art can make are given without departing from the gist of one aspect of the present disclosure.

An exhaust gas purification catalyst of the present disclosure is a filter catalyst obtained by coating a catalyst material inside the wall of a filter substrate (in-wall coating), which is disposed in an exhaust passage of an internal combustion engine to purify exhaust gas discharged from the internal combustion engine. More specifically, the exhaust gas purification catalyst of the present disclosure is a filter catalyst obtained by segregating a catalyst material inside an exhaust gas outflow side of a porous filter wall of a substrate having a wall-flow structure. The wall-flow structure has a honeycomb structure having a plurality of cells extending in the axial direction from one end face to the other end face and a filter wall (also referred to as a “partition wall”) partitioning the cells. In the wall-flow structure, the cells of the honeycomb structural body are alternately plugged at one end or the other end to form end-plugged portions. In the exhaust gas purification catalyst of the present disclosure, the filter wall is porous and has many pores inside thereof, and the surfaces of the pores on the exhaust gas outflow side are coated with a catalyst material.

Furthermore, in the exhaust gas purification catalyst of the present disclosure, in an x-y line diagram with a wall thickness (μm) from the exhaust gas inflow side of the exhaust gas purification catalyst as the x-axis and a porosity (%) at the wall thickness as the y-axis, in the range of a wall thickness from the exhaust gas inflow side of 200 μm or more and 230 μm or less, the integral value (area) of the difference between the porosity at the wall thickness and a porosity of 40% (hereinafter, also referred to as “area S”) is 587 μm·% or more. Note that x=0 is the exhaust gas inflow side surface of the exhaust gas purification catalyst.

In the exhaust gas purification catalyst of the present disclosure, the product pressure loss of the exhaust gas purification catalyst can be reduced by adjusting the area S to the range described above.

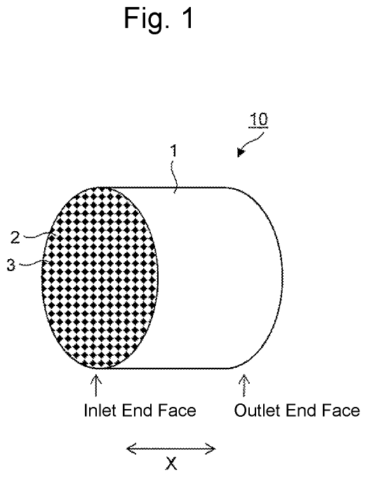

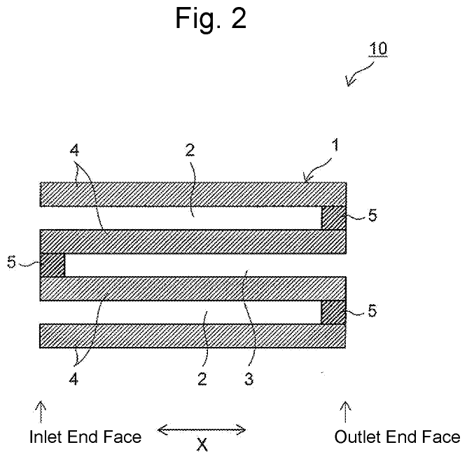

FIG. 1 and FIG. 2 illustrate one embodiment of the exhaust gas purification catalyst of the present disclosure. FIG. 1 is a perspective view schematically illustrating an exhaust gas purification catalyst 10. FIG. 2 is a schematic diagram of an enlarged part of a cross-section of the exhaust gas purification catalyst 10 cut in an axial direction X. In the exhaust gas purification catalyst 10, a substrate 1 has inlet-side cells 2, outlet-side cells 3, and a porous filter wall 4. The inlet-side cell 2 has an open end on the inlet end face side and an end on the outlet end face side plugged with a plugged portion 5. The outlet-side cell 3 is adjacent to the inlet-side cell 2, has an open end on the outlet end face side, and has an end on the inlet end face side plugged with the plugged portion 5. The filter wall 4 partitions between the inlet-side cell 2 and the outlet-side cell 3. Although not illustrated, the surfaces of pores inside the filter wall 4 on the exhaust gas outflow side are coated with a catalyst material. In the exhaust gas purification catalyst 10, exhaust gas passes through the filter wall 4 from one surface to the other surface of the filter wall 4.

The material of the substrate is, but is not limited to, for example, cordierite, aluminum titanate, SiC, Si-bonded SiC, or mullite, and in one embodiment, cordierite is used from the viewpoint of cost.

The thickness of the filter wall of the substrate before coating with the catalyst material is, but is not limited to, usually in the range of 230 μm or more and 400 μm or less, and 240 μm or more and 300 μm or less in one embodiment, from the viewpoints of suppressing pressure loss and securing sufficient strength.

The filter wall of the substrate before coating with the catalyst material has, but is not limited to, a porosity usually in the range of 40% or more and 80% or less, and 50% or more and 70% or less in one embodiment, from the viewpoints of suppressing pressure loss and securing sufficient strength.

The average pore size of the filter wall of the substrate before coating with the catalyst material is, but is not limited to, usually in the range of 5 μm or more and 40 μm or less, and 7 μm or more and 20 μm or less in one embodiment, from the viewpoint of particulate matter trap performance.

In the exhaust gas purification catalyst of the present disclosure, the catalyst material is coated inside the exhaust gas outflow side of the filter wall of the substrate, that is, from the exhaust gas outflow side surface to the inside. In other words, in the exhaust gas purification catalyst of the present disclosure, the catalyst material is formed on the inside of the exhaust gas outflow side of the filter wall of the substrate. The catalyst material may be formed in one layer or two or more layers. In some embodiments, one layer or two layers are formed. Note that the catalyst material does not necessarily have a uniform structure as a whole, and it may have, for example, a single-layer structure or a dual-layer structure for each predetermined range in the axial direction.

The catalyst material contains, but is not limited to, an OSC material having oxygen storage capacity and a catalyst metal.

As the catalyst metal, conventionally known catalyst noble metals for exhaust gas purification catalysts can be used. Examples thereof include noble metals, such as platinum (Pt), palladium (Pd), rhodium (Rh), ruthenium (Ru), iridium (Ir), and osmium (Os). In one embodiment, palladium (Pd) and rhodium (Rh) are used. Only one catalyst metal may be used, or a combination of two or more catalyst metals may be used. Combinations of catalyst metals include a combination of Pt and Rh. In this case, each catalyst metal may be contained in a different layer.

The catalyst metal may be supported on a carrier. The carrier on which the catalyst metal is supported is not limited, and examples thereof include an aluminum oxide (alumina: Al₂O₃), a zirconium oxide (zirconia: ZrO₂), a silicon oxide (silica: SiO₂), and composite oxides containing these oxides as the main components.

The OSC material is an inorganic material having oxygen storage capacity (OSC), and the OSC material occludes oxygen when a lean exhaust gas is supplied and releases occluded oxygen when a rich exhaust gas is supplied, thereby making it possible to enhance exhaust gas purification performance against the fluctuation of the oxygen concentration in exhaust gas. Examples of OSC materials include a cerium oxide (ceria: CeO₂), composite oxides containing the ceria (for example, a ceria-zirconia composite oxide (CZ or ZC composite oxide)), and the like. Among the OSC materials, a ceria-zirconia composite oxide can be used because it has a high oxygen storage capacity and is relatively inexpensive. In one embodiment, the OSC material may be used in the form of not supporting a catalyst metal. In one embodiment, the OSC material supports a catalyst metal, and the OSC material is a ceria-zirconia composite oxide.

The coating amount of the catalyst material on the filter wall is usually in the range of 30 g/L or more and 200 g/L or less per substrate volume, and 45 g/L or more and 100 g/L or less per substrate volume in one embodiment. When the coating amount is 30 g/L or more, pressure loss significantly decreases while securing sufficient exhaust gas purification performance and oxygen storage capacity. When the coating amount is 200 g/L or less, exhaust gas purification performance and oxygen storage capacity significantly increase while securing sufficiently low pressure loss.

In the exhaust gas purification catalyst of the present disclosure, the thickness at which the catalyst material is segregated in the filter wall, that is, the thickness from the exhaust gas outflow side surface at which the catalyst material is coated (also referred to as “coating thickness”) is not limited as long as the area S is within the above range. However, the coating thickness is usually in the range of 30 μm or more and 200 μm or less, and 40 μm or more and 140 μm or less in one embodiment.

In the exhaust gas purification catalyst of the present disclosure, the product pressure loss of the exhaust gas purification catalyst can be further reduced by adjusting the coating thickness to the above range.

The exhaust gas purification catalyst of the present disclosure can be used as a GPF catalyst.

The exhaust gas purification catalyst of the present disclosure can be manufactured by, for example, adding an additive to a slurry containing a catalyst material, coating a filter wall of a substrate with the slurry from the exhaust gas outflow side, and then drying and firing the resulting coated product. In other words, a method for manufacturing the exhaust gas purification catalyst of the present disclosure includes a step of coating a filter wall of a substrate with a slurry containing a catalyst material, for example, an OSC material having oxygen storage capacity and a catalyst metal, from the exhaust gas outflow side after adding an additive, specifically, a polyethylene oxide-based viscosity modifier, such as a polyethylene oxide whose viscosity average molecular weight is in the range of 600,000 or more and 10,000,000 or less to the slurry to obtain an exhaust gas purification catalyst in which the catalyst material is coated inside the filter wall, and a step of drying and firing the exhaust gas purification catalyst in which the catalyst material is coated inside the filter wall.

The slurry of the catalyst material can be obtained by dispersing a catalyst metal, which is supported on a carrier, if necessary, and an OSC material in a solvent such as water, and adding thereto an additive, such as a polyethylene oxide-based viscosity modifier. The catalyst metal, the carrier, and the OSC material are used in powder form in some embodiments.

The viscosity average molecular weight of the polyethylene oxide, which can be used as a viscosity modifier, is in the range of 600,000 or more and 10,000,000 or less in one embodiment, 1,700,000 or more and 10,000,000 or less in one embodiment, 3,300,000 or more and 10,000,000 or less in one embodiment, and 8,000,000 or more and 10,000,000 or less in one embodiment. Here, the viscosity average molecular weight is a molecular weight known to those skilled in the art, which can be calculated using the viscosity formula [η]=KM^{a} (in the formula, K and a are values that depend on the types of polymer and solvent and the temperature of measurement, and do not depend on the polymerization degree of the polymer, and can be obtained experimentally), from the intrinsic viscosity [η] of the polymer dilution solution obtained by a capillary viscometer.

Since the viscosity modifier is added in an additive amount that allows the viscosity of the slurry of the catalyst material to fall within a specific range, the additive amount (content) of the viscosity modifier is not limited. However, the additive amount is usually in the range of 0.26% by weight or more and 1.70% by weight or less with respect to the total weight of the slurry, and the additive amount is usually in the range of 0.83% by weight or more and 5.55% by weight or less with respect to the total weight of the solid content.

The slurry viscosity after adding the viscosity modifier is adjusted to usually less than 2000 m·Pas, less than 1500 mPa's in one embodiment, and 1000 mPa·s or less in one embodiment, under the conditions of a measurement temperature of 25 °C and a shear rate of 4 s⁻¹. Although the lower limit value of the slurry viscosity is not limited, the slurry viscosity is usually 1 mPa·s or more, 10 mPa·s or more in one embodiment, and 50 mPa·s or more in one embodiment, under the conditions of a measurement temperature of 25 °C and a shear rate of 4 s⁻¹. In this description, the slurry viscosity refers to the viscosity measured with an E-type viscometer (TVE-35H, manufactured by Toki Sangyo Co., Ltd.) using a rotor type of 1°34′×R24 at a measurement temperature of 25 °C and a shear rate of 4 s⁻¹.

The solid content of the slurry of the catalyst material is not limited as long as the slurry viscosity is within the above range. However, the solid content is usually in the range of 20% or more and 50% or less with respect to the total weight of the slurry.

In the slurry of the catalyst material, the average particle size of the powder in the slurry is usually in the range of 0.1 μm or more and 20 μm or less, and 0.5 μm or more and 7 μm or less in one embodiment. In the present disclosure, the average particle size means the value of 50% cumulative particle size (D50 diameter) measured by the laser diffraction scattering method. The particle size of the powder in the slurry can be adjusted by, for example, mixing slurry components with a solvent (such as water) and treating the mixture by grinding (for example, wet grinding).

Coating the filter wall with the slurry can be performed by, for example, applying the slurry to the filter wall for coating (coating by suction of the slurry under reduced pressure or spray coating by air blowing) at room temperature, for example, a temperature in the range of 15 °C or higher and 40 °C or lower. For example, the coating can be performed by the wash coating method, in which, after the outflow-side cells are filled with a slurry, the slurry is suctioned from the inflow-side cells.

The coating width (in the axial direction, the coating width (%) relative to the overall length of the filter wall) for coating the slurry of the catalyst material is not limited. In one embodiment, the slurry is coated within a coating width of usually 50% or more and 100% or less, and 65% or more and 100% or less in one embodiment.

Subsequently, the exhaust gas purification catalyst in which the catalyst material is coated inside the filter wall is dried and fired.

The temperature, time, atmosphere, and the like of drying and firing are not limited, and the conditions known in the relevant technical field can be used. For example, drying can be performed by allowing the drying air to pass from the exhaust gas outflow side of the substrate coated with the catalyst material. The wind speed of the drying air is, but is not limited to, usually 10 m/s or less, 8 m/s or less in one embodiment, and 6 m/s or less in one embodiment. While the lower limit value of the wind speed of the drying air is not limited, the wind speed of the drying air is usually 1 m/s or more, and 2 m/s or more in one embodiment. Note that “m/s” stands for “m/second.” Furthermore, the temperature of the drying air is, but is not limited to, usually 50 °C or higher, and 90 °C or higher in one embodiment, as well as usually 200 °C or lower, and 150 °C or lower in one embodiment. Therefore, the temperature is usually in the range of 50 °C or higher and 200 °C or lower, and 90 °C or higher and 150 °C or lower in one embodiment. The drying time is, but is not limited to, usually in the range of 1 minute or more and 30 minutes or less. The firing temperature is, but is not limited to, usually in the range of 400 °C or higher and 600 °C or lower. The firing time is, but is not limited to, usually in the range of 30 minutes or more to 4 hours or less. The firing atmosphere is usually an air atmosphere.

For the slurry of the catalyst material, depending on the number of catalyst metals used, one slurry may be used, or two or more slurries containing different catalyst metals may be used. Two slurries may be used to form a first catalyst material and a second catalyst material. A catalyst metal may be preliminarily supported on a carrier powder. Alternatively, after a catalyst material is coated, dried, and fired, a catalyst metal may be supported on the formed catalyst material by a known supporting method, such as a water-absorption supporting method or an adsorption supporting method.

### EXAMPLES

The following describes the present disclosure more specifically using examples. However, the technical scope of the present disclosure is not limited to these examples.

### Examples 1 to 4 and Comparative Examples 1 and 2

A honeycomb substrate with a wall-flow structure made of cordierite was used as a substrate. The substrate had a cell count of 200 cpsi (cells per square inch), a volume of 1.3 L, an overall length of 122 mm, a diameter of 118 mmφ, a filter wall average pore size of 7 μm, and a filter wall porosity of 58%.

A composite oxide containing alumina, zirconia, ceria, and the like, a catalyst metal including one or more selected from the group consisting of Pt, Pd, Rh, and the like, pure water, and a viscosity modifier listed in Table 1 were mixed and stirred to prepare a slurry containing a catalyst material and a viscosity modifier. The slurry viscosity after adding the viscosity modifier was measured with an E-type viscometer (TVE-35H, manufactured by Toki Sangyo Co., Ltd.) using a rotor type of 1°34′×R24 under the conditions of a measurement temperature of 25 °C and a shear rate of 4 s⁻¹. All results were less than 2000 m·Pas.

The filter wall was coated with the slurry at room temperature from the outlet side of the substrate by wash coating, then dried by introducing the drying air at 90 °C at a wind speed of 4 m/s from the outlet side of the substrate, and fired at 500 °C for one hour, thereby preparing a filter catalyst.

TABLE 1
Sample List

| | | Integral Value | |
|---|---|---|---|
| | | of Difference | |
| | | from Porosity = | Product |
| Comparative | Viscosity | 40% (Area S) | Pressure |
| Examples/Examples | Modifier | (μm · %) | Loss (kPa) |
| Comparative Example 1 | HEC 900 | 501.04 | 4.81 |
| Comparative Example 2 | HEC 400 | 387.55 | 5.15 |
| Example 1 | PEO-3 | 732.23 | 4.45 |
| Example 2 | PEO-8 | 587.36 | 4.45 |
| Example 3 | PEO-15 | 1085.4 | 4.43 |
| Example 4 | PEO-29 | 1105.6 | 4.43 |

In Table 1, HEC 900 is hydroxyethyl cellulose (viscosity average molecular weight: 1.54 million) manufactured by Daicel Corporation, and HEC 400 is hydroxyethyl cellulose (viscosity average molecular weight: 1.20 million) manufactured by Daicel Corporation. PEO-3 is a polyethylene oxide (viscosity average molecular weight: in the range of 600,000 or more and 1,100,000 or less, and 5% aqueous solution viscosity: in the range of 2,500 mPa·s or more and 5,500 mPa·s or less) (25 °C, rotor No. 3)) manufactured by Sumitomo Seika Chemicals Company, Limited, PEO-8 is a polyethylene oxide (viscosity average molecular weight: in the range of 1,700,000 or more and 2,200,000 or less, and 0.5% aqueous solution viscosity: in the range of 20 mPa·s or more and 70 mPa·s or less (25 °C, rotor No. 1)) manufactured by Sumitomo Seika Chemicals Company, Limited, PEO-15 is a polyethylene oxide (viscosity average molecular weight: in the range of 3,300,000 or more and 3,800,000 or less, and 0.5% aqueous solution viscosity: in the range of 130 mPa·s or more and 250 mPa·s or less (25 °C, rotor No. 1)) manufactured by Sumitomo Seika Chemicals Company, Limited, and PEO-29 is a polyethylene oxide (viscosity average molecular weight: in the range of 8,000,000 or more and 10,000,000 or less, and 0.5% aqueous solution viscosity: in the range of 800 mPa·s or more and 1000 mPa·s or less (25 °C, rotor No. 2)) manufactured by Sumitomo Seika Chemicals Company, Limited. The viscosity of the aqueous solutions of the polyethylene oxides manufactured by Sumitomo Seika Chemicals Company, Limited, is the viscosity measured at 12 rpm using a B-type viscometer (Brookfield LVT type Viscometer).

### Evaluation

For the filter catalysts of Examples 1 to 4 and Comparative Examples 1 and 2, the porosity at each position along the wall thickness (μm) from the exhaust gas inflow side was measured. The porosity was measured as described below.

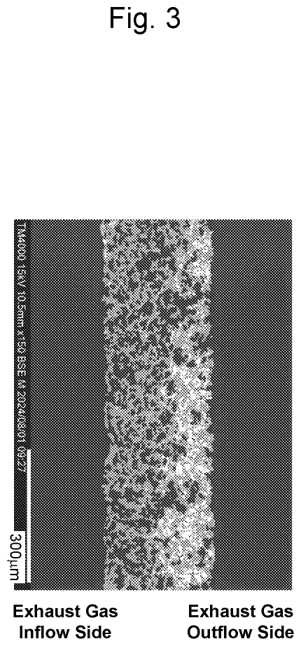

First, an SEM image of each filter catalyst was taken. As an example, FIG. 3 illustrates the SEM image of the filter catalyst of Example 1.

Subsequently, the SEM image was ternarized to create an SEM-1D profile. For the ternarization, the average value of the coating part was obtained from three images for each sample, and a moving average using a window of ten points was applied to the profile.

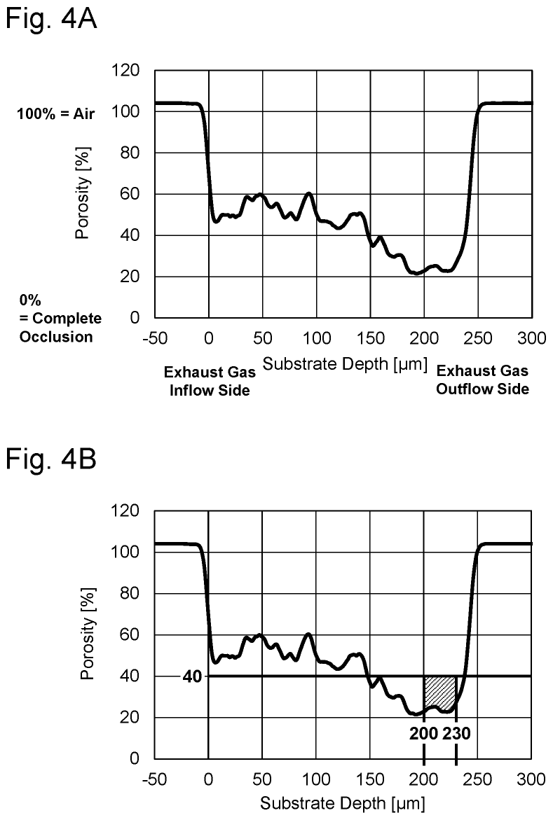

FIG. 4A illustrates an x-y line diagram of the filter catalyst of Example 1, with the wall thickness (μm) from the exhaust gas inflow side as the x-axis and the porosity (%) at the wall thickness as the y-axis. On the x-axis, the positive direction is the exhaust gas outflow side. On the y-axis, 0% means complete occlusion, and 100% means air.

Subsequently, for each filter catalyst, in the range of the wall thickness from the exhaust gas inflow side of 200 μm or more and 230 μm or less, the integral value of the difference between the porosity at the wall thickness and the porosity of 40% (area S) was obtained. In FIG. 4B, the area S of the filter catalyst of Example 1 is indicated as the hatched portion.

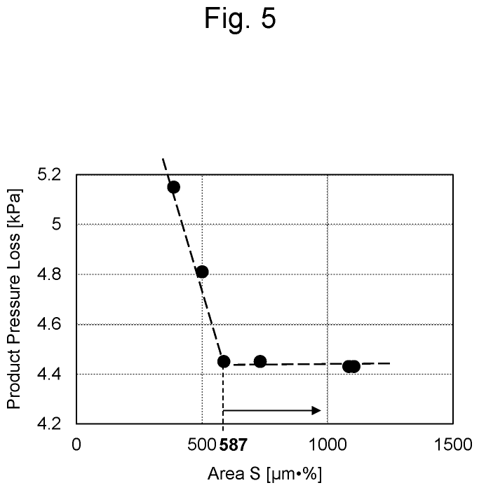

Table 1 shows the area S of each filter catalyst, and FIG. 5 shows the relationship between the area S and product pressure loss. From Table 1 and FIG. 5, it was found that there is a linear correlation between the area S and product pressure loss when the area S of the filter catalyst is up to 587 μm·%, and that when the area S of the filter catalyst is 587 μm·% or more, the product pressure loss remains at a certain low level regardless of the area S.

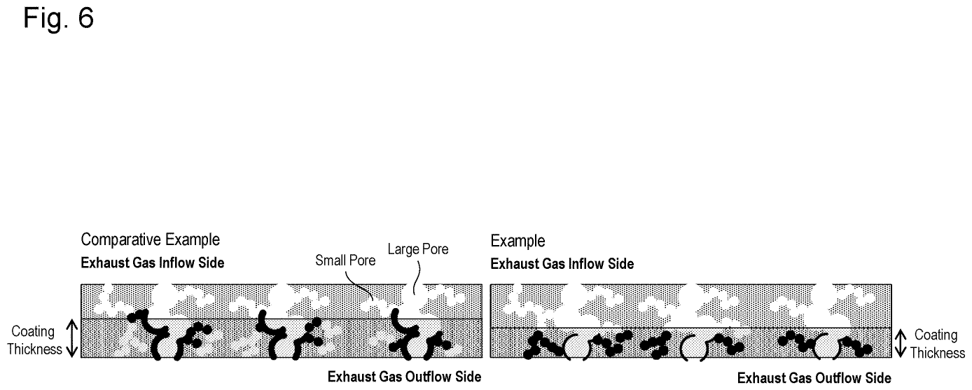

FIG. 6 illustrates a cross-sectional schematic diagram of the filter walls of the filter catalysts of Comparative example and Example. Here, the volume of the slurry injected into the comparative example and the example is constant. In the schematic diagram of the comparative example in FIG. 6, the slurry with low fluidity during the drying process does not penetrate small pores completely. As a result, the coating thickness on large-pore surfaces increases, and neck portions become narrower, and the product pressure loss increases. On the other hand, in the schematic diagram of the example in FIG. 6, the slurry with high fluidity even during the drying process sufficiently penetrates small pores. This is because a slurry with high fluidity can increase the coat filling rate to the small pores according to the capillary force acting more strongly as the diameter of a tube is smaller. As a result, the coating thickness on large-pore surfaces decreases, neck portions are not narrowed, and the product pressure loss remains small.

All publications, patents and patent applications cited in the present description are herein incorporated by reference as they are.

What is claimed is:

1. An exhaust gas purification catalyst comprising:
a substrate having a wall-flow structure, and a catalyst material being coated inside a porous filter wall of the substrate,
wherein the catalyst material is segregated inside an exhaust gas outflow side of the substrate, and
wherein in an x-y line diagram with a wall thickness (μm) from an exhaust gas inflow side of the exhaust gas purification catalyst as an x-axis and a porosity (%) at the wall thickness as a y-axis, in a range of a wall thickness from the exhaust gas inflow side of 200 μm or more and 230 μm or less, an integral value of a difference between the porosity at the wall thickness and a porosity of 40% is 587 μm·% or more.

2. The exhaust gas purification catalyst according to claim 1,
wherein a coating amount of the catalyst material is in a range of 30 g/L or more and 200 g/L or less, with respect to a substrate volume.

3. A method for manufacturing an exhaust gas purification catalyst comprising a substrate having a wall-flow structure, and a catalyst material being coated inside a porous filter wall of the substrate, the method comprising:
coating the filter wall of the substrate with a slurry comprising a catalyst material from an exhaust gas outflow side after adding a polyethylene oxide-based viscosity modifier to the slurry to obtain an exhaust gas purification catalyst in which the catalyst material is coated inside the filter wall; and
drying and firing the exhaust gas purification catalyst in which the catalyst material is coated inside the filter wall.

4. The method according to claim 3,
wherein a slurry viscosity after adding the viscosity modifier is adjusted to less than 2000 mPa·s under conditions of a measurement temperature of 25 °C and a shear rate of 4 s⁻¹.

5. The method according to claim 3,
wherein in the drying the exhaust gas purification catalyst in which the catalyst material is coated inside the filter wall, a temperature of a drying air is in a range of 50 °C or higher and 200 °C or lower, and a wind speed of the drying air is in a range of 1 m/s or more and 10 m/s or less.
